(19) United States
(12) Patent Application Publication
(10) Pub. No.: US 2014/0216232 A1
(43) Pub. Date: Aug. 7, 2014

(54) SHATTER-RESISTANT DRUMSTICKS FROM SUSTAINABLE MATERIALS

(71) Applicants: David Wayne Reid, Hoboken, NJ (US); David Richard Violi, Upper Black Eddy, PA (US)

(72) Inventors: David Wayne Reid, Hoboken, NJ (US); David Richard Violi, Upper Black Eddy, PA (US)

(73) Assignee: BOSO MUSIC, LLC, Hoboken, NJ (US)

(21) Appl. No.: 13/665,931

(22) Filed: Nov. 1, 2012

Related U.S. Application Data
(60) Provisional application No. 61/671,092, filed on Jul. 12, 2012.

(51) Int. Cl. G10D 13/00; G10D 13/02

(52) U.S. Cl. CPC G10D 13/003; G10D 13/02
USPC 84/411 R; 84/422.4; 264/294

(57) ABSTRACT

Disclosed herein are drumsticks comprising agricultural fibers from monocots, particularly grasses. The disclosed drumsticks provided excellent playability, improved grip, are less susceptible to chipping, splintering, or shatter than wood drumsticks, are harder, lighter, and more durable than comparable wooden sticks. The disclosed drumsticks offer a crisper more even sound at all volumes even during dynamic performance, and are superior in damping vibrations. Also disclosed are methods for making the drumsticks and kits comprising drums and drumsticks.

### CROSS-REFERENCE TO RELATED APPLICATIONS

This claims benefit of U.S. Provisional Patent Application Nos. 61/553,928 filed Oct. 31, 2011, and 61/671,092 filed Jul. 12, 2012 the entireties of which are incorporated herein by reference.

### BACKGROUND

1. Field of the Invention

This relates generally to implements such as drumsticks and other sticks for striking and/or playing drums and other percussion instruments made of compressed agricultural fibers. More particularly this relates to improved drumsticks and other implements made of compressed bamboo, and methods for making bamboo drumsticks.

2. Description of Related Art

Drumming and related percussive behaviors (e.g. footdrumming, thumping, and the like) have been observed in a wide range of mammals from rodents to great apes. Drumming is believed to provide a means of communicating various messages. Nonhuman primates have been observed beating on drum-like substrates in a variety of natural settings using either their hands or implements (e.g. sticks).

For humans, drums and other percussion instruments predate recorded history. The earliest humans are believed to have played percussion instruments, first with their hands, and later with implements for striking. Some have speculated that drumming has its roots in an attempt to recreate the sound of the womb, or to imitate the powerful lub-dub of one's own heartbeat. But whether for that purpose, or to socialize and bond while drumming in circles, to accompany celebratory singing and dancing, to signal other people or groups regarding danger or battle, to commemorate a solemn occasion, or even just to enjoy the backbeat of rock and roll music, mankind has always been fascinated with and moved by drumming and percussive rhythms.

Both the instruments and the implements for striking have changed over time. Modern implements for striking percussion instruments, particularly drums, began to take shape as the modern drumstick in the 20^{th} century and to become more standardized over the last 80 years. As seen in FIG. 1, drumsticks 100 now generally have similar designs which all feature several structures. At one end is the tip 110 or the main striking portion of the stick. Tips 110 can be of various sizes and shapes, e.g. rounded, teardrop, barrel-shaped, pointed, triangular, etc. Tips 110 may be rubberized for some applications or coated with polymers such as nylon. At the other end of the stick is the butt or the butt-end 140. Prior art drumsticks almost universally have a rounded butt-end. In some drumming applications the drummer may flip the stick and strike with the butt of the stick to produce a different sound or intensity. Drumsticks with tip-like butts are known.

Between the tip end 110 and the butt end 140, lies the main portion or body 130 of the drumstick. The body 130 is used primarily for gripping the stick 100, and may feature various designs such as groves, knurls, fluting, or the like for improving the grip and reducing the slippage problem discussed below. Again, in some applications, the body 130 of the stick may be used by drummers for striking.

The area of the stick 100 behind the tip 110 and connecting to the body 130 is referred to as the shoulder 120, which generally tapers down from the body 130 to the tip 110. The profile (i.e. shape) of the taper can vary greatly both in terms of the amount of taper between the main body 130 and the tip 110, as well as where the taper begins and ends, and any curve within the taper. The shoulder 120 can maintain the same circumference as the main body 130 and then narrow just before the tip 110 attaches, or the shoulder 120 could gradually taper from the body 130 to the tip 110, or any combination thereof. A shorter, more abrupt taper will generally provide a stiffer stick 100 while a long slender taper will typically result in a more flexible stick 100, each with their own sound characteristics.

Standard sizes for drumsticks have developed. Among the more common sizes are 3S, 2B, 5B, 5A, and 7A where the number/letter combination refers to the size and designated use or application. With the exception of 3S, the numbers indicate the circumference with higher number having a smaller circumference. For unknown reason the 3S has a greater circumference than the 2B. The letter associated with the stick size reflects the designated use, with ‘S’ indicating “Street” use such as for marching bands, parade units, and drum corps. The mass of these sticks allows for naturally big sound and good volume. ‘B’ indicates recommended use for “Bands” including for example symphonic concert bands, brass bands, and rock bands. The letter ‘A’ denotes intended use for “Orchestra” application, i.e. for lighter applications including big bands, dance bands and orchestras. Of course professional drummers are artists who know their own needs, preferences and performance styles, and the standardized sizes merely inform the drummers of a sticks' general properties and do not limit the actual applications of any size sticks.

In very general terms, 5A, the most common stick, is a lighter stick used widely in rock and roll, and 7a, a smaller, still lighter stick is used for softer music, jazz, and the like. While these sizes were reasonably standardized, manufacturers could make their own sticks unique by customizing features, such as the tip design and the taper of the stick. In addition to the standard sizes, many manufacturers offer their own proprietary sizes to the market.

The materials for drumstick construction have also been somewhat standardized. In the last few decades, drumsticks have predominantly been constructed out of wood, particularly hickory, oak, and maple. Perhaps surprisingly to beginners, while these are all woods, the properties have been determined through experience to be quite different with respect to the sound generated, and other properties of the sticks. For example, oak sticks are generally heavier and denser sticks that do not break easily, however they tend to be slower playing, and have very little energy absorption so that they can be stiff and hard on a drummer's hands. Hickory sticks, which are the most common drumsticks, have intermediate density and weight, as well as intermediate energy absorption. In contrast, maple sticks are much less dense and therefore lighter and faster in playing. They have much better energy absorption, but are more difficult to generate maximal sound. Many other woods have been used for drumsticks including more or less exotic or expensive woods, each of which provides different qualities ranging from unique appearance to increased durability to varied sound. Examples include rosewood, bubinga, ebony, and mahogany. Again, drummers tend to choose the type and style of stick, including material that best suits their playing style and personal preferences and beliefs.

Despite the improvements and attempts at standardization, basic problems persisted with inconsistent manufacture; the sticks' weight varied, and they did not produce consistent sound qualities at all volumes. Moreover, the sticks were often warped and/or slippery and/or would shatter unpredictably.

Other problems also remain. For example, sticks are still subject to unpredictable and catastrophic failure, e.g. shatter, as well as chipping. Shattered sticks are a substantial problem for performing drummers. Even if sticks don't shatter, they can chip and splinter. The chips and/or splinters create debris in the percussion instrument, for example a drummer's ‘kit,’ creating a maintenance issue.

Another important issue is grip. Many wooden sticks can be quite slick. It is not uncommon for a player to drop or lose a stick during a performance. While some sticks are left with a natural finish after sanding, in most cases the wooden sticks are finished with a lacquer coating. Either type of finish can be slippery or become slippery, e.g. especially from the natural oils or perspiration from a player's hand. To compensate for this limitation, many players use gloves; others tape their sticks or the like to attempt to improve the grip on the sticks.

Several alternatives to wooden sticks have been investigated including a number of synthetic materials. For example, nylon or other synthetic polymeric sticks are now available. Efforts are ongoing to get such sticks to provide the desirable properties of wooden sticks, without the associated problems. Unfortunately, the polymeric sticks have been found wanting by many professional drummers. Similarly, sticks that have nylon-coatings are available but have not overcome the problems with conventional wooden sticks. Coated sticks can include drumsticks wherein just the tip of the stick is coated, or where the one or more other portions of the stick have been coated. Aluminum drumsticks are also known, generally with coated with PVC or other plastic, for either the entirety or at least a portion comprising the tip of the stick. Such sticks, e.g. with rubberized tips, may be primarily useful in play electronic drum pads, i.e. digital drums wherein the sound is produced electronically in response to a player striking a digitized surface.

Other materials that have been used for drumsticks include graphite and other forms of carbon materials, fiberglass, and various composites comprising two or more materials for example carbon materials and nylon, or wood and synthetic material.

There is a continuing need for novel drumsticks that overcome one or more of the limitations of traditional drumsticks.

### SUMMARY

Certain agricultural fibers have been used to make ‘green’ or sustainable structural building materials including medium density fiberboard (MDF), oriented strand board (OSB), particleboard, plywood, wheatboard, strawboard, panel substrates, and door cores. Such materials are often collectively referred to as agrifiber and can comprise fibers from bagasse (i.e. sugar cane), cereal straw, cornstalks, cotton stalks, kenaf, rice husks, rice straw, sunflower hulls, sunflower stalks and the like. A process for producing “Compressed Agricultural Fiber” (CAF) panels was invented in Sweden in 1935, and developed into a commercial product in Britain under the name Stramit in the late 1940s. After the patents expired, various companies used the Stramit process throughout the world. Fibers from sorghum and wheat have also been used to make laminated sorghumboard and wheatboard, respectively. In recent years, laminates (e.g. plywood) have also been made of bamboo, which has long been used in Asia as a building material. More recently in the West bamboo has become popular as a wood alternative in flooring applications employing compressed and or strand woven bamboo.

The inventors have discovered that drumsticks comprising compressed agricultural fibers, such as bamboo, have many surprising and unpredictable benefits. Bamboo drumsticks provide a replacement to the use of wood, which can take decades to grow, with a fast growing agricultural material; bamboo is known to grow up to 48″ in a single day. The entire process of growing, harvesting, and manufacturing can be conducted in a highly sustainable manner. In addition, the entire process up to and including manufacture can be done in an organic manner, and thus can be fully ‘green,’ i.e. environmentally friendly and safe.

The inventors have discovered that while the sticks may be made from many agricultural fibers, that drumsticks made from bamboo fibers, in particular, provide several additional unexpected and valuable qualities.

For example, bamboo drumsticks provide a natural, slightly tacky surface or texture that accentuates the grip of players of any skill level.

Unlike wooden drumsticks, bamboo sticks do not chip, splinter, or create debris or mess on and around the drum kit. Although the sticks may dent with use, and ultimately weaken, the drum and other percussion instrument is not subject to accumulating broken bits and splinters of drumstick and the drummers investment in equipment/drums/instruments is thereby protected.

Bamboo is also resistant to shatter, particularly as compared to a wooden stick of substantially similar dimensions. Instead of catastrophic failure in the form of e.g. shatter that is typical of wood sticks, bamboo sticks will gradually fade and weaken. This change is noticeable by the drummer in both the feel and sound produced, and the performer can readily dispose of/eliminate the weakened stick(s) prior to a sudden and unexpected breakage during a performance.

Bamboo is stronger than oak, and lighter than hickory, thus it also allows for fast performance and excellent sound quality and volume. And while it could not have been predicted, the sound quality is unique as discussed below in more detail. Moreover, by varying the manufacturing process, the inventors have discovered ways to manufacture sticks of varied hardness, which provides a great deal of flexibility in offering drumsticks of different properties with the same raw material. This flexibility is not possible with sticks made of e.g. a traditional hardwood, or most synthetic raw materials.

Thus, given these and other benefits, in a first of the several aspects of this disclosure, the inventors have provided drumsticks made of renewable agricultural fibers. The fibers are not derived from hardwood (e.g. dicot species) nor softwood (e.g. conifers), but rather from monocot species, such as grasses (including bamboos, cereals, etc.), bagasse, palms, and the like. The drumsticks are manufactured such that the final product is harder than a comparable wood stick, for example an oak or even hickory drumstick.

The drumsticks may comprise woven fibers in some applications (e.g. strand woven bamboo). In other embodiments, the drumsticks comprise only non-woven fibers. A particularly preferred source of the fibers is bamboo. In one embodiment the manufacturing preferably includes a step of laminating the fibers together, to produce, for example, laminated bamboo.

The resultant drumsticks are strong (e.g. stronger than oak), lightweight (e.g. lighter than hickory), resistant to chipping, splintering, shatter, or breakage relative to comparable wooden sticks, and produce an excellent quality sound. The sticks offer improved gripping as compared to other sticks, particularly standard wooden sticks with either a natural finish or a lacquer finish.

The drumsticks disclosed herein produce little or no debris even after extensive use, and have excellent resistance to shatter, chipping, splintering or the like. The inventive drumsticks have a unique property in that they weaken gradually with prolonged use and the sound produced fades thereby providing an early warning system that they need to be replaced. They also provide excellent acceleration and vibration damping properties.

In addition, with respect to sound, as compared to traditional wood drumsticks the drumsticks made of agricultural fiber provided herein produce:
1. crisp, rounded sounds on drum heads during dynamic performances at both low and high volumes; and
2. warm, even sounds when striking cymbals or hard surfaces during dynamic performances at both low and high volume.

Another aspect of the invention provides drumsticks with the butt-end modified so as to substantially decrease the angle of attack when the butt end is used to strike a percussion instrument such as a cymbal or the like.

A further aspect of the invention provides methods for manufacturing drumsticks and related implements for striking or playing drums or percussion instruments from agricultural fiber. The methods generally comprise the steps of selecting an agricultural fiber, preferably from a monocot species and more preferably bamboo; drying the fibers and/or separating the fibers from any undesirable material; optionally weaving strands of the fibers to obtain a woven product; compressing the woven or non-woven fibers together with one or more resins, binding, bonding, or curing agents sufficiently to produce a compressed bulk stock, preferably having a hardness greater than that of hickory; drying to a suitable moisture level, cutting the compressed stock to approximate size, shaping to a dowel or drumstick blank, turning the drumstick blanks on a lathe to produce drumsticks; and optionally further sanding or finishing the turned drumsticks.

Another aspect of the invention provides kits comprising together in a single package, or in separate packages, one or more drums or other percussion instruments and one or more drumsticks comprising bamboo. The kits optionally comprise any one or more of instructions for use; written, video, or audio information on drumming or how a consumer can benefit from the kit; a label or other indicia that encourages or promotes use of renewable resources, sustainable agriculture, organic produces, good stewardship of the earth or the environment, or ‘green’ products, or a label or other indicia indicating the drumsticks contained therein contain or are made with renewable resources, sustainable agriculture or organic products or processes; or a link (in the form of a URL) to a website that comprises information on any of the foregoing.

These and/or further aspects, features, and advantages of the present invention will become apparent to those skilled in the art in view of this disclosure.

### BRIEF DESCRIPTION OF THE DRAWINGS

FIG. 1: A representation of a drumstick showing the typical parts including the tip end 110, the shoulder 120 and taper, the body 130, and the butt end 140 of the stick 100.

FIG. 2: A flow chart showing an example of a process for making a non-woven bamboo drumstick.

FIG. 3: A flow chart showing a representative process for making drumsticks with strand woven bamboo fibers.

FIG. 4: A diagram showing one advantage of altering the attack angle by modifying the butt end of the drumstick in certain embodiments herein.

### DETAILED DESCRIPTION

Provided herein are drumsticks made of agricultural fibers. The agricultural fibers provided herein are from monocot species, such as species of grasses, particularly bamboo. Drumsticks made of these agricultural fibers, for example bamboo provide several distinct advantages and benefits over the wooden and or synthetic sticks that are predominant in the current market.

Thus, the inventors have discovered that the drumsticks disclosed herein unexpectedly provide a substantially improved grip over current stick. The materials have a slight natural tackiness that actually maintains and improves grip for drummers of all levels during performance, rather than traditional sticks which may be somewhat slippery initially and get more slippery as the drummer works and perspires. In addition the drumsticks provided herein are stronger than some of the strongest wooden sticks available (e.g. Japanese oak) while simultaneously being lighter than e.g. hickory sticks. This combination of excellent strength and light weight make for excellent performance properties, allowing fast and hard play.

Surprisingly, the inventors have also discovered that despite both the hardness/strength and the lightweight nature of the drumsticks described herein, the sticks do not chip, splinter or shatter. Despite the hardness of the sticks dent and the material gradually weakens and fades. Such weakening and fading can readily be detected by a drummer and the sticks can be replaced rather experiencing a catastrophic shatter during a performance. The ability to avoid breakage of a stick during a performance, and the disruption associated therewith is a substantial benefit of the sticks developed by the inventors. The elimination of chips and splintering help to keep the drum kits clean and well-maintained.

Moreover the ability of the innovative sticks provided herein to accelerate under an applied force is preferably at least as good as that of a traditional wooden drumstick, as is the ability to dampen low frequency vibrations. The ability of the sticks provided herein to dampen high frequency vibrations is preferably superior to that of the traditional wooden drumsticks. Thus, despite having a lighter weight, the sticks are easier to play with because they dampen high-energy vibrations.

Bamboo in various forms has been used as a building material, a flooring material, and even as a material for certain traditional percussion instruments. The inventors, one of whom is a professional drummer, has found no evidence of the use of bamboo as a drumstick, nor for any application in conventional drumming including rock, jazz, funk, blues, reggae, R&B, African drumming, or the like. Where bamboo has been used in connection with an implement for drumming it has been used not as a drumstick, but rather as bound fibers that function like wire brushes, or as short thick clubs used to hammer large drums (e.g. kettledrums, timpani, or the like).

Interestingly, in Japan where bamboo is recognized and valued as a material for many uses, bamboo has been used for various instruments including flutes (e.g. shakuhachi). However, traditional Japanese drums (e.g. taiko drums) are generally struck with oak bachi (sticks) that are approx. 2″ in diameter and 18″ or so in length. Bamboo bachi (“take bachi”) are not entirely unknown, however, take bachi are long, slightly flat sticks that are carved from bamboo. They must generally be wrapped in tape or cloth to prevent splintering and to add additional weight. In addition, unlike the sticks disclosed herein which create an excellent quality sound, take bachi are described as making a sharp, slapping sound that is less resonant than the sound of wood sticks.

### DEFINITIONS & ABBREVIATIONS

Unless expressly defined otherwise, all technical and scientific terms, terms of art, and acronyms used herein have the meanings commonly understood by one of ordinary skill in the art in the field(s) of the invention, or in the field(s) where the term is used. In accordance with this description, the following abbreviations and definitions apply.

As used herein, the singular form of a word includes the plural, and vice versa, unless the context clearly dictates otherwise. Thus, the references “a”, “an”, and “the” are generally inclusive of the plurals of the respective terms. For example, reference to “a drumstick” or “a player” includes a plurality of such “drumsticks” or “players.”

The words “comprise”, “comprises”, and “comprising” are to be interpreted inclusively rather than exclusively. Likewise the terms “include”, “including” and “or” should all be construed to be inclusive, unless such a construction is clearly prohibited from the context. Further, forms of the terms “comprising” or “including” are intended to include embodiments encompassed by the phrases “consisting essentially of” and “consisting of”. Similarly, the phrase “consisting essentially of” is intended to include embodiments encompassed by the phrase “consisting of”.

Where used herein, ranges are provided in shorthand, so as to avoid having to list and describe each and every value within the range. Any appropriate value within the range can be selected, where appropriate, as the upper value, lower value, or the terminus of the range.

The methods and devices and/or other advances disclosed here are not limited to particular methodology, protocols, and/or structures described herein because, as the skilled artisan will appreciate, they may vary. Further, the terminology used herein is for the purpose of describing particular embodiments only, and is not intended to, and does not, limit the scope of that which is disclosed or claimed.

Although any devices, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent permitted under applicable law. Any discussion of those references is intended merely to summarize the assertions made therein. No admission is made that any such patents, patent applications, publications or references are prior art, or that any portion thereof is either relevant or material to the patentability of what is claimed herein. Applicant specifically reserves the right to challenge the accuracy and pertinence of any assertion that such patents, patent applications, publications, and other references are prior art, or are relevant, and/or material.

As used herein a “drumstick” refers to any implement used for striking or playing a drum or other percussion instrument. Thus as used herein, “drumstick” includes any stick, mallet, or related implement comprising a body or handle gripped by a drummer and a tip or head for striking a drum or percussion instrument. While a drumstick according to this disclosure comprises agricultural fibers, the drumstick may also comprise other material in specific embodiments, for example, the while the handles of mallets may be made from the agricultural fibers to obtain many of the advantages described herein, the heads may require other materials. The skilled artisan will appreciate that the description of drumsticks herein which relates to the replacement of traditional materials with agricultural fiber such as bamboo, does not preclude the use of additional materials or structures as would normally be used with a particular stick or mallet in addition to, e.g., wood.

The term “drum” or “percussion instrument” as used herein are interchangeably and refer to a single- or multi-headed drum of any size or shape including cylindrical, barrel, conga, waisted, goblet, or bowl-shaped drums, whether pitched or unpitched, and specifically includes snare drums, bass drums, tom toms, tenor drums, side drums, taiko drums, timpani, kettledrums, nakers, steel drums, tabors, cymbals of any type including a ride cymbal, crash cymbal, splash cymbal, china boy, or hi hat. Other percussion instruments included for use herein include any makeshift drum, as well as any block including wood blocks, anvil, gong, clapper, bell, pipe, sistra, triangle, chime, xylophone, metallophones, glockenspiel, marimba, vibraphone, tam-tam, or the like. In addition this definition includes any drum or percussion instrument that is normally play with the hands to the extent sticks are ever used to strike them. Examples of such instruments might include bongos, cajon, congas, djembe, tabla, as well as tambourines and various shakers. For purposes herein, any electronic, simulated, or digital drum or percussion instrument that is intended or adapted to be played, or can be played, with sticks on any pad or the like is also expressly included. For purposes herein, a specific ‘drumstick’ need not be applicable to all of the foregoing, however generically ‘drumsticks’ may be used for playing any of the foregoing. For example, a particular application (e.g. a digital drum) may best be met with a particular style or type of stick (e.g. a stick with a rubberized or coated tip), whereas other applications may not require or be well-suited to that particular type of stick. The skilled artisan will appreciate the difference from the context in which the term is used.

The term “agricultural fiber” as used herein refers to any natural fiber from a plant, crop, tree, or the like, however, agricultural fibers as used herein expressly exclude fibers comprising woody xylem, e.g. fibers from hardwood and softwood species (e.g. dicots and conifers). Preferred agricultural fibers are derived from monocot species, such as grasses and palms. Bamboo is particularly preferred because of its rapid growth rate and excellent properties for drum sticks. The structure of these fibers is different from those of woods currently used for drumsticks. The lack of secondary growth wood causes the stems of monocots, even of palms and large bamboos, to be columnar rather than tapering. Agricultural fibers can preferably be sustainably maintained. In addition to bamboo, fibers can be derived from crops such as cereal crops (also true grasses) (e.g. amaranth, barley, buckwheat, fonio, maize, millet, oats, quinoa, rice, sorghum, teff, triticale, wheat), sugar cane, or any crop that produces fibrous straw, stalks or the like.

As used herein “bamboo” refers to any of the species of true grasses in the family Poaceae, subfamily Bambusoideae, tribe Bambuseae. Bamboos, including giant bamboos, are generally perennial evergreens, and include the largest members of the grass family. Some species grow as ‘trees’ that are as tall as 100 to 175 feet tall. Presently preferred bamboos for use herein include Chinese Sichuan bamboos, for example members of the genus Bambusa or Phyllostachys, such as P. pubescens, P. nigra, or P. edulans, as well as B. edulis or B. heterocycla, particularly those species considered to be “Moso” bamboo. Bamboo from the Zhejiang province, such as from the Anji area are also presently preferred for some applications herein.

Palm ‘wood’ can also be used in various embodiments. As used herein, palm ‘wood’ includes the fiber from any palm, but particularly from coconut palms that are no longer productive. A large quantity of these trees are still discarded and it is believed that this source of fiber will be useful in connection with making drumsticks disclosed herein.

As used herein “compressed” refers to the result of “compression” which is the process of compacting agricultural fibers together with or without resins, bonding agents, binding agents, curing agents or other additives. Compression includes any form of compression whether by mechanical, pneumatic, or other means. Compression may be conducted at any temperature or humidity, and with any other process parameters that are beneficial to the end-result, i.e. the compressed fibers. Compression of fibers may be conducted in one or more cycles under the same or different process conditions. Fiber compression may be used with either woven or non-woven fibers. Compression of fibers may be continued or repeated until a desired end goal, such as a particular hardness is obtained.

As used herein, “hardness” is a measure of a material's resistance to being pierced, or indentation. Hardness may be measured by any test designed to measure such properties of materials in general or wood in particular. One presently preferred measure is the Janka hardness, which specifically is used to measure of resistance of wood to indentation. The Janka hardness test measures the force required to press a steel ball into a test specimen of wood until the ball has penetrated to half its diameter and formed an indentation with an area of 100 square millimeters (mm²). Hardness is distinguished from density, which is weight per unit volume (e.g. g per cubic inch, or kg per cubic meter, etc.), measured at a defined moisture content (e.g. 12%). While there is generally a fairly direct correlation between density and hardness, there are exceptions, and some materials may be both less dense and also harder than other materials that are denser but not as hard. This appears to be a function of a number of factors including the molecular and macromolecular structure of the materials. For example, ebony and jarrah each have a density of 820 kg/m³, and yet ebony is much harder than jarrah as measured by the Janka hardness test. The Janka hardness test has become almost a standard test for assessing the quality of wood flooring materials. An ideal material for drumsticks would be a material with a lower density relative to its hardness, i.e. a material that is lighter and harder, rather than a material that is heavier and softer.

### ABBREVIATIONS

The following abbreviations apply unless indicated otherwise:

CAF: compressed agricultural fiber;
g: grams;
in: inch;
kg: kilograms;
lbf: pounds force (a measure of hardness);
m: meters;
m³: cubic meters;
mm: millimeters;
mm²: square millimeters;
MDF: medium-density fiberboard;
OSB: oriented strand board;
PVC: polyvinyl chloride;
R&B: rhythm & blues; and

### URL: Uniform Resource Locator.

### DETAILED DESCRIPTION OF ILLUSTRATIVE EMBODIMENTS

In a first of it several aspects, provided herein are drumsticks comprising agricultural fibers derived from monocot species. The drumsticks have several properties of interest to drummers of all levels. For example the drumsticks feature one or more of the following properties:

a) they provide enhanced gripping as compared to a comparable wooden drumstick, whether with a natural (sanded) finish or with a lacquered finish;

b) they are less subject to chipping or splintering as compared to a comparable wooden drumstick, and do not generate debris on the drums;

c) they are more resistant to catastrophic failure (e.g. shatter) as compared to a comparable wooden drumstick;

d) they are harder than a comparable wooden stick made of oak or hickory;

e) they produce improved sound quality on drums at all volumes even during dynamic performance; and/or

f) they have enhanced vibration-damping properties, particular for damping higher frequency.

In presently preferred embodiments, the drumsticks disclosed herein provide all of the foregoing properties.

In one embodiment, the drumsticks disclosed herein further optionally comprise:

g) a modified butt-end that allows a decreased angle of attack when using the butt end of the drumstick to strike a cymbal or similar percussion instrument; and/or

h) a color that is substantially different from a comparable hickory, oak, or maple drumstick for ready identification, for example to allow the sticks to readily be identified in a drummer stick bag.

In various embodiments, the improved grip offered by the drumsticks disclosed herein is a function of one or more of a) the natural tackiness of the raw material (e.g. bamboo), and b) the manufacturing process of the sticks including the compression and machining to shape and size.

In preferred embodiments, the sticks comprising agricultural fiber are less subject to chipping or splintering as compared to a comparable wooden drumstick, and do not generate debris on the drums. These drumsticks are also more resistant to shatter or unexpected breakage as compared to a comparable wooden drumstick. Rather than chipping, splintering, shattering or breaking the novel sticks have a tendency to dent, weaken and fade over time with use. The drummer can readily detect the weakened stick and cull it prior to catastrophic failure of the stick. Even during a performance the drummer could readily replace a stick prior to it shattering, particularly given the fact that the innovative sticks are readily distinguished visually from other sticks in the drummer's stick bag.

In another embodiment, the drumsticks comprising agricultural fiber are harder than comparable wooden sticks made of e.g. maple, oak, or hickory. As discussed below, the hardness can be selected during manufacture by altering for example, either or both of the compression of the agriculture fibers and/or the degree of weaving fibers. Other factors that may be modified to contribute to the hardness of the final sticks include the resin, binding agents, bonding agents, curing agents, hardeners, or the like, as well as the process conditions including temperature, humidity and the like.

The fact that these sticks dent and weaken relative to comparable wooden sticks is both surprising and useful. Because the sticks disclosed herein are harder than the comparable wood drumsticks, one would reasonably expect them to be more difficult to indent since hardness is a measure of the ability to be indented. However, just as the correlation between density and hardness is not perfect, the inventors have discovered that the traditional wood drumsticks are in one respect more ‘resistant’ to denting—i.e. they tend to shatter, chip or splinter, whereas the drumsticks of this disclosure despite being harder materials will dent rather than shatter, chip, or splinter. Accordingly either there is not a perfect correlation between hardness and denting, or more likely there are other factors determined by the structure of grain of the wood or fibers from which the stick is made that allow a harder stick to yield (i.e. dent) and the less hard stick to shatter, chip, or splinter.

Stated another way, while hardness measures, such as the Janka hardness test, are designed for predicting the ability of hardwood flooring to be dented, the test is intended for use on a static flooring, not on small relatively light pieces of wood (or other material) that are subjected to repeated dynamic vibrational forces as are drumsticks. Under those ‘in use’ conditions' it has been empirically determined that the comparable wooden drumsticks are far more prone to shatter, chipping and splintering, while the drumsticks disclosed herein despite having greater hardness under the static, are more susceptible to denting and gradual weakening, and more resistant to shatter, chipping, and splintering.

Preferably the sticks provide improved ability to dampen vibrations as compared to traditional wooden sticks.

In another embodiment, the drumsticks comprising the agricultural fiber produce improved sound quality on drums at all volumes even during dynamic performance. The improved sound is experienced in at least two ways; on drumheads the sound is generally crisper, more rounded sound than is obtained from wooden sticks.

Typically traditional wooden sticks (e.g. hickory sticks) produce a brighter sound that is often consistent at all volumes and difficult to control. It often cuts through even when the performance requires less. The drum player will often switch to a lighter stick to avoid this problem or must reduce the force of each stroke to create a rounded tone. Using the sticks disclosed by the inventors, the drum player can play at any volume or speed and produce the same sound regardless of the amount of energy applied.

In one embodiment, the sticks are made from any agricultural fiber derived from a monocot species, preferable a grass species. Preferred grasses include cereals. In one embodiment, the sticks comprise bamboo fibers such as natural bamboos, Mao bamboos, or Moso bamboos. Presently preferred embodiments feature laminated bamboo. Preferred bamboos are species that are larger than about 2″ in diameter. Asian bamboos are utilized and particularly Chinese bamboos. In one embodiment, Zhejiang or Sichuan bamboos are used, such as various species (or synonyms) referred to herein as Moso bamboo.

In preferred embodiments, the culturing, growing and harvesting of the agricultural fiber, e.g. bamboo, are done in an environmentally-conscious manner, for example using nontoxic or organic treatments, fertilizers and the like, minimizing water usage, not destroying forest or other native crops to raise the source of agricultural fiber, minimizing and/or utilizing waste products so as for helping offset fossil fuel/energy needs, composting, and/or other alternative uses. In more preferred embodiments, the entire production process is ‘green’, sustainable and organic such that any environmental impact is negligible particularly as compared to the harvesting and processing of hardwood for traditional hickory, oak, or maple drumsticks.

Preferably the bamboo is at least about a year old. More preferably the bamboo is more than one year old, such as 2-3 years old, 3-4 years, 4-5 years, or 5-6 years old or even older.

In one embodiment the agricultural fiber is derived from palm. While palm is not rapid growing, palm wood is essentially sustainable because it is obtained from retired (nonproductive) trees such as coconut palm. Many thousands of these trees are removed each year to allow for replanting of new trees. New uses are needed for this resource. The wood has excellent properties in terms of hardness, and like bamboo and other agriculture fibers disclosed herein, is expected to be useful for drumsticks. One advantage of palm wood is that is sufficiently hard such that it will not likely require compression prior to manufacturing drumsticks.

In another embodiment, the drumsticks comprise a blend of agricultural fibers, which are formulated to optimize the performance and sound properties of the stick. Such drumsticks may comprise any of the fibers disclosed herein in any proportions and the blends may further comprise resin, binding agents, bonding agents, curing agents, hardeners, or the like.

In one presently preferred embodiment, the sticks comprise bamboo that has been laminated. Laminated bamboo may include any of a variety of bamboo fibers and resin, binding agents, bonding agents, curing agents, hardeners, or the like, or a combination thereof. Conditions for laminating bamboo include maintaining the fibers and laminating mixture at a pressure and temperature combination for a time sufficient to cure or laminate the fibers. In one embodiment woven fibers are pressed at substantially higher pressures than non-woven fibers. Presently preferred conditions include about 400 tons to about 2000 tons of pressure. For example, strand woven bamboo can be laminated at 1500-2000 tons of pressure, while non-woven strands can be laminated at about 500-1000 tons. In one embodiment non-woven bamboo is laminated at 700-900 tons while strand woven is laminated at 1700-1900 tons.

The laminated bamboo is cured or pressed, then cut into suitable dimension boards for subsequent use. In one embodiment boards are cut to thicknesses of about 0.3 to about 1 cm. The boards may be dried e.g. in an oven, kiln, or air-dried. Temperatures below 100 degrees C. are preferred. Preferably the boards are dried at about 50-80 degrees C. for about 80-150 hours. In one embodiment laminated bamboo boards are dried at about 60 C for about 120 hours. Generally sufficient moisture is removed to prevent mold growth in the material. In one embodiment, the laminated material is dried to a moisture content of less than about 15%. More preferably the final moisture content of the bamboo is less than 14, 13, 12, 11, or even 10%.

In various embodiments, multiple such boards may be laminated together. The resultant material may be cut into blanks for turning out completed sticks. For example in one embodiment, a sheet of non-woven laminated bamboo about 0.5 inches (0.4 to 0.6 inches) is sandwiched between two sheets of strand woven laminated bamboo about 0.75 inches (0.5 to 1 inches) each.

In another embodiment, the entirety of the stick is produced from the agricultural fiber along with any required or useful additives. In other embodiments, the stick includes other components, for example a tip covering that may be made from other material. While any material including synthetic material may be used for such other component (e.g. tip covering), presently preferred components are made from natural materials, and particularly environmentally-friendly material such that the overall product has a favorable environmental appeal, or image.

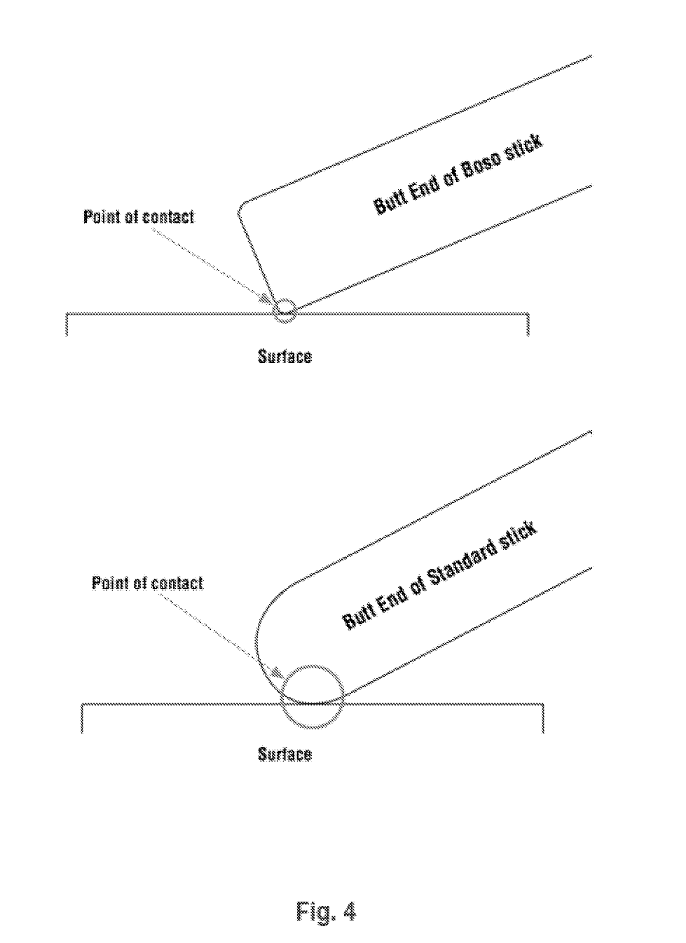

Another aspect of the invention provides a drumstick comprising a modified butt-end that provides a decreased angle of attack when using the butt end of the drumstick to strike a cymbal or similar percussion instrument. With reference to FIG. 4B, it can be seen that the prior art provides a drumstick 400 with a body 430 that has a rounded butt end 440. As can be seen, when the rounded butt end 430 strikes a surface 490 of e.g. a drum, a somewhat diffuse point of contact 485 is created based on the angle of attack between the stick 400 and the surface 490. Unlike the rounded butt end 440 of available prior art sticks, the sticks disclosed herein have a flat butt end 440 that is at about a 90-degree angle relative to the long axis of the stick 400 (as seen in FIG. 4A). By decreasing the angle of attack between the surface 490 and the butt end of the stick 440, the point of contact 485 is reduced or more focused. As can be seen by comparing FIGS. 4A and 4B, this results in more force per unit area being transmitted to from the drummer through the drumstick 400 to the percussion instrument. This produces sharper, more distinct tones compared to striking with a rounded butt-end that is typical of available (prior art) drumsticks. This flattened design and the advantages it provides may be used with drumsticks made of any material, including sticks comprising the same agricultural fibers as disclosed herein.

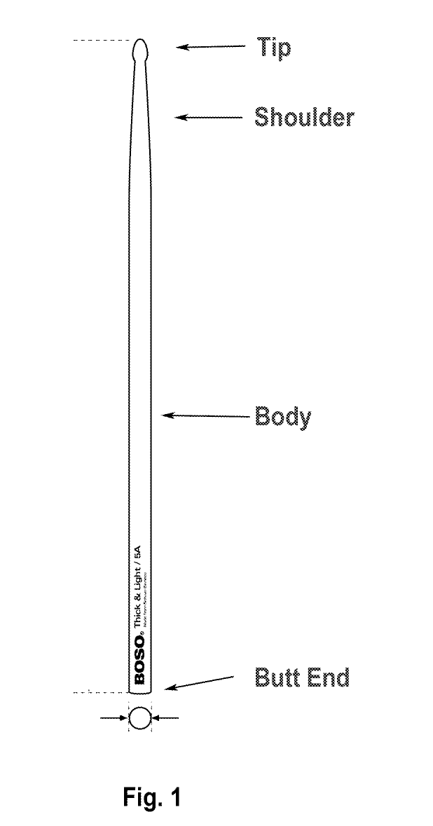

In one embodiment, the generally flat butt end e.g. 140 or 440 of the stick 100 or 400 can be engraved with the manufacturers logo, indicia, quality symbol, or the like, or it can show the size of the stick, or provide other marking that enables that drummer to quickly locate that size or type stick in his stick bag. In one embodiment, the butt-end contains a laser engraved letter, such as a stylized or block B to represent the manufacturer (see e.g. FIG. 1).

In yet another aspect of the invention, provided herein are methods of manufacturing drumsticks from agricultural fibers derived from monocots. Where required, the fibers are mechanically compressed sufficiently with resin, bonding agents, binders, hardeners, and/or curing agents to provide a suitable hardness, preferably such that the final product is harder than hickory or oak.

For purposes herein oak has a hardness of about 1200-1400 pounds force (lbf) as measured for example via the Janka hardness test, performed in accordance with the standards in ASTM D 1037-7 testing methods. The hardness of hickory is about 1800-1850 lbf. The temperatures and other conditions of the compression may be adjusted as required to accomplish the goal. Additives, including one or more resins, bonding agents, binders, adhesives, hardeners, curing agents, coloring agents, or the like can be added. Preferably the additives are nontoxic, and themselves comprised of renewable resources, and more preferably they are organic. In addition, the fibers may be dried sufficiently to provide a shelf-stable product, generally resistant to rot, microbial decay, insect damage, or the like.

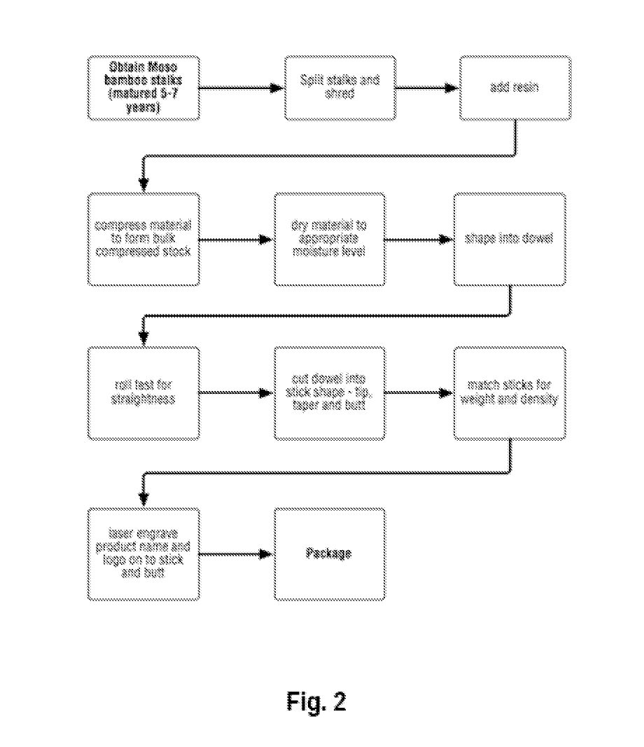

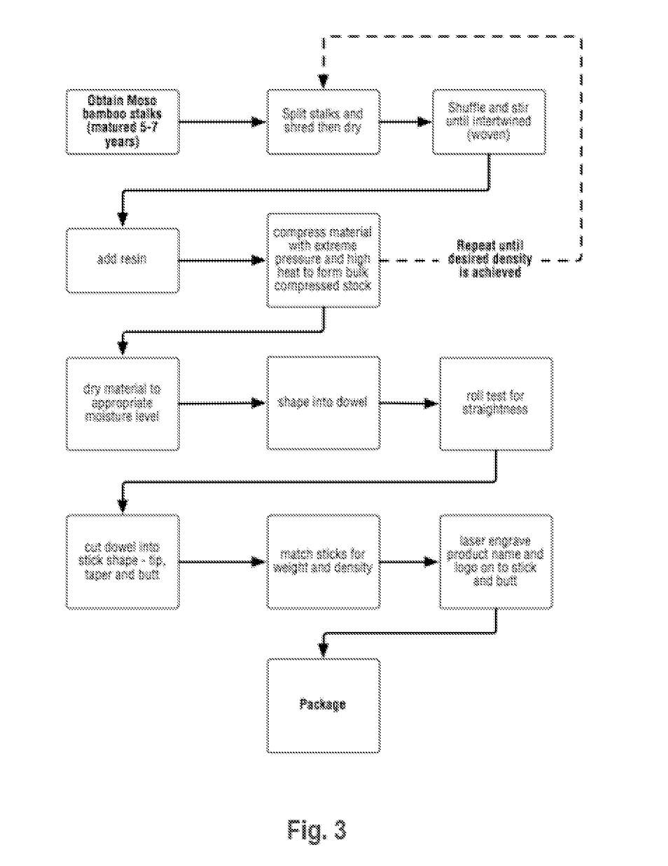

In addition, the processes/methods for producing drumsticks can be conducted with non-woven or woven fibers. FIG. 2 exemplifies a process 200 for non-woven fibers, while FIG. 3 shows a similar process 300 using strand woven fibers.

With reference to the figures, FIG. 2 depicts an embodiment of a process 200 for making drumsticks comprising agricultural fibers. As can be seen, as exemplified the process uses bamboo. Moso bamboo with mature stalks (e.g. 5-7 years) are harvested. The natural bamboo material, i.e. the stalks, are at a minimum about 2″ in diameter and the maximum size is at least about 6″ in diameter. Moso bamboo is relatively thick walled and the stalks are relatively straight along their length.

Unlike Tonkin bamboo used to make poles for gardeners, Moso bamboo features nodes that are closer together and more pronounced. This bamboo is commonly used for making bamboo flooring because it is very strong, e.g. stalks over 2″ cannot be bent easily by hand.

In another embodiment (not shown) the bamboo is natural bamboo from Zhejiang province in China. The bamboo is preferably 3-4 years old, but can any age from about a year old to 5-7 years old.

Regardless of the source of the fibers, the stalks are split, dried, and/or shred. Resin and or other additives are generally added. It is noted that some agriculture fibers can be bound or fused together using high compression and high heat without any additives, and such processes may be used in connection with this disclosure where applicable. In the case of bamboo however, it is presently preferred to include resin.

A bulk stock material is then formed by compressing the mixture of bamboo fibers and resin under conditions providing suitable pressure, temperature and/or humidity (see e.g. FIG. 2, steps 214, 216). The bulk stock material is cured and dried under suitable condition depending on the requirements of the additives, and the desired final moisture content for the sticks (step 218).

The bulk stock material is then cut and shaped into dowels approximately the size of drumsticks (step 220). Since the final drumsticks must be uniform and consistent in terms of size and shape, the dowels are test for straightness (e.g. by rolling). Dowels that are sufficiently straight are e.g., cut to length and then cut into the final shape including the tip, taper and butt (steps 222, 224). Preferably the final cutting and shaping are done by turning the dowel on a lathe. For large-scale production, CNC machines may generally be useful for cutting the cured material/producing the dowels. CNC lathes in particular may be useful for producing the final drumsticks.

In a preferred embodiment, as shown in FIG. 2, the sticks are matched for weight and density (e.g. step 226). Because there are natural variations in the material there will necessarily be variation in the individual final sticks. This is also true for wooden drumsticks.

In order to provide a high-quality drumming experience, such sticks are preferably matched for weight/density such that a given pair of sticks of a certain size have no more than a predetermined difference in weight. The skilled artisan will appreciate the acceptable amount of difference may be a percentage of the total weight of the stick or may be a specified number of, e.g., grams or ounces of variation. For example, the weight of a given stick size may be specified as 2.0 ounces plus or minus 0.2 ounces, but the paired matches may be with 0.1 or less of each other. One set of sticks of that particular size might weigh on average 2.1 ounces and another 1.95 ounces but both pairs would be matched within 0.1 ounces. The actual amount of variation within a size or within a pair can be more or less than the example provided, determined in fact as the market needs and quality control capabilities dictate.

As with many drumsticks on the market today, the sticks produced according the methods herein may be laser engraved, embossed, labeled, painted, or otherwise marked on the body of the stick and/or on the butt end (step 228). After the engraving step is complete, the sticks can be packaged for retail and/or wholesale markets including pairs, or larger quantities of weight-matched sticks, or even individually (step 230).

With reference to FIG. 3, an exemplary process 300 for making drumsticks comprising strand-woven agricultural fiber (e.g. bamboo) is depicted. As above, the steps of obtaining the stalks and splitting, shredding, and/or drying them as needed are the same (e.g. steps 310, 312). After obtaining the fibers (e.g. shredded bamboo material), the material is shuffled or stirred, e.g. by hand, using mechanical means, using air movement, etc.) until the strands are intertwined (step 314). The degree of intertwining desirable may depend on the desired weight/density of the final product. A heavier product can be produced with more intertwining. Additives such as resins, binding agents, bonding agents, curing agents, hardeners, coloring or the like may be added as desired at this stage. For bamboo, resins are preferred.

The mixture of resin and fiber is then subjected to compression under condition of extreme pressure (e.g. about 400 to about 2000 tons) and high heat to form a bulk stock material (e.g. steps 316, 318).

In a preferred embodiment, the drumsticks are made or agricultural fibers comprising bamboo fibers, and conditions for laminating the bamboo include maintaining the fibers and, as described above, the laminating mixture at a pressure and temperature combination for a time sufficient to cure or laminate the fibers. In one embodiment woven fibers (e.g. process 300) are pressed at substantially higher pressures than non-woven fibers (e.g. process 200). Presently preferred conditions include about 400 tons to about 2000 tons of pressure. For example, strand woven bamboo can be laminated at 1500-2000 tons of pressure, while non-woven strands can be laminated at about 500-1000 tons. In one embodiment non-woven bamboo is laminated at 700-900 tons while strand woven is laminated at 1700-1900 tons.

In one embodiment the agricultural fibers comprise bamboo and one or more other materials. More preferred are drumsticks wherein the agricultural fibers consist essentially of bamboo fibers. In other embodiments, the agricultural fibers consist solely of bamboo.

In the process 300, as can be seen in FIG. 3, the steps of shredding, intertwining, adding resin and compressing (i.e. steps 312, 314, 316, and 318) may be repeated until sufficient/desired density is achieved. The compressed bulk material tends to darken slightly on each repeated cycle of compression and high heat.

After compressed bulk material having the desired density is obtained, the steps are essentially the same as for the non-woven material. In particular, the material in dried to a suitable moisture level, made into dowels, tests for straightness, shaped into drumsticks having the proper tip, taper, shoulder, and butt, then weight/density matched, engraved, and packaged (see e.g. steps 320, 322, 324, 326, 328, 330, and 332 respectively.

As with the non-woven process preferred fibers presently are from natural bamboo, Mao bamboo, or Moso bamboo of at least about one year old, however fibers from any grasses or other monocots are useful herein. The sticks made according to the process 300 of FIG. 3 will tend to be heavier/denser than those made according to the process for non-woven fibers. Any degree of intertwining can be accomplished, and unique or intermediate properties may be obtained by combining intertwined fibers with non-woven fibers prior to the final compression.

In another aspect of the invention, kits are provided including one or more drums and one or more drumsticks in accordance with this disclosure. It is noted that the term ‘kit’ is also short hand for a term of art for drummers (i.e. the ‘drum kit’) and that is not the intended use herein, although the kits provided in this aspect of the of the invention may include a drum kit to fulfill the requirement for at least one drum. The kits comprise, together in a single package, or in separate packages, one or more drums or other percussion instruments and one or more drumsticks comprising bamboo or other agricultural fibers disclosed herein. The kits may be particularly targeted at beginning drummers. The drumsticks disclosed herein are excellent for professional because of their performance properties, but are also ideal for beginners because the grip is greatly improved and this allows the beginning drummer to overcome the fear of losing/dropping the stick and thereby relax his/her grip for improved performance. In addition to the drum(s) and drumsticks, the kits optionally comprise any one or more of instructions for use; written, video, or audio information on drumming or how a consumer can benefit from the kit; information about selecting drumsticks based on physical and musical properties thereof, a label or other indicia that encourages or promotes use of renewable resources, sustainable agriculture, organic produces, good stewardship of the earth or the environment, or ‘green’ products, or a label or other indicia indicating the drumsticks contained therein contain or are made with renewable resources, sustainable agriculture or organic products or processes; or a link (in the form of a URL) to a website that comprises information on any of the foregoing.

### EXAMPLES

The invention can be further illustrated by the following examples, although it will be understood that the examples are included merely for purposes of illustration and are not intended to, and do not limit the scope of the invention unless otherwise specifically indicated.

### Examples

### Feedback from Professional Drummers

First generation bamboo drumstick prototypes were made. Samples were provided to several professional drummers for initial testing and feedback prior to improving the process for making the bamboo sticks. The comments generally related to the feel, the tone (i.e. sound), and/or durability of the bamboo sticks. Among other things, the drummers reported that they did not expect bamboo to keep up with their hard style of play; that the sticks “feel alive in my hands making the performance fee more musical”; that brand new sticks feel the same as the pair that the drummer had been using for six months; and that the bamboo sticks consistently delivered “the basics” and also offered “a variety of interesting and unique sounds.”

Producing Drumsticks from Non-Woven Moso Bamboo

Drumsticks were produced by the method exemplified in FIG. 2. The method was readily capable of making sticks of 1.2-2.0 ounces. Sticks of size 5A were readily made from the material. The sticks manufactured had a natural bamboo color and feel. The sticks were paired by matching weight/density and tested by a professional drummer playing a standard drum kit. The drumsticks provided excellent grip that did not require extraneous tape. The sticks were lightweight and strong and stood up to hard play, yet felt responsive. The bamboo sticks resisted chipping and did not splinter. Over time with repeated use, the sticks dented and weakened, but they did not shatter or break suddenly, rather they weakened and the sound they produced faded. The drummer was able to know when they needed to be replaced. The butt end of the sticks was flat, i.e. cut at about a 90-degree angle to the long axis of the stick. This provided excellent sound when striking the cymbals. The sticks produced a good quality sound that was crisp regardless of the volume or intensity of play.

Producing Drumsticks Comprising Strand-Woven Moso Bamboo

Drumsticks were produced by the method exemplified in FIG. 3. The method was readily capable of making sticks of 2.5-3.0 ounces. The sticks could readily be made as size 5B. The natural bamboo color darkened of the material during repeated cycles of compression at high temperature and humidity. The sticks were darker than those made by the procedure of FIG. 2. The butt end of the sticks was not rounded but rather was about 90-degree angle to the long axis of the stick. The sticks were paired by matching weight/density and tested by a professional drummer playing a standard drum kit. The drumsticks provided excellent grip that did not require extraneous tape, and felt sturdy and solid to hold and play with. The bamboo drumsticks resisted chipping and did not splinter, but rather dented. Over time with repeated use, the sticks weakened, but they did not shatter or break suddenly, rather they weakened and the sound they produced faded. The drummer was able to know when they needed to be replaced. The sound was excellent at all volume levels and independent of the speed of play. When playing cymbals with the butt end, the sticks gave an excellent sound that was distinguishable by the trained ear from the sound produced by standard wooden sticks.

Comparative Testing of Bamboo Versus Traditional Hickory Drumsticks

A comparison was performed to assess the amount of acceleration and the damping properties of bamboo drumsticks as described herein vs. traditional hickory drumsticks after being struck by a wooden ball traveling at approximately 400 ft/sec.

Impact Testing

Tests were conducted by independent testing laboratories. All equipment was calibrated according to ISO 10012-1 and calibration was traceable to the National Institute of Standards and Technology (NIST). Calibration records were maintained on file at independent testing laboratories.

The drumsticks were shot with a 0.5″ wooden (maple) ball traveling at approximately 400 ft/sec. The drumstick orientation was both with the grain and also against the grain.

Test Procedure

Each drumstick was clamped into a holding fixture with an accelerometer attached 4.75″ from the tip of the drumstick. A 0.5″ wooden (maple) ball was shot perpendicularly into the drumstick by means of a compressed gas cannon using nitrogen (15 psi). The projectile averaged about 0.686 grams. The strike point was 2.5″ from tip of the drumstick. The drumsticks were struck in each of two orientations (with the wood grain and against the wood grain). Acceleration as well as high frequency and low frequency damping properties were measured using an accelerometer and oscilloscope. The data were recorded and are shown below in Table 1:

IMPACT DATA SHEET

| | | |
|---|---|---|
| Job Number: PR016812 | Date: Jun. 26, 2012 | Page 1 of 1 |

| | |
|---|---|
| Client: Boso Music | P.O. No.: CC |
| Test: Impact | Test Item: Bamboo Drumsticks |
| Specification: | Model or P/N: 7A, 5A |
| Para./Sect: | S/N(s): N/A |

Note: Marker Line indicates with “Grain”. (see photos in Appendix C)
Projectile

| | |
|---|---|
| Projectile Type | 0.5″ Wood (maple) ball |
| Projectile Average | 0.686 grams (0.0242 oz.) |
| Mass | |
| Launch Pressure | 15.0 PSI |
| Gas Type | Nitrogen |
| Impact Angle | Perpendicular to target |

Target

| | Test-1 | Test-2 | Test-3 | Test-4 | Test-5 | Test-6 | Test-7 | Test-8 |
|---|---|---|---|---|---|---|---|---|
| | Vic-7A | Vic-7A | Boso-7A | Boso-7A | Vic-5A | Vic-5A | Boso-5A | Boso-5A |
| | with Grain | against Grain | with Grain | against Grain | with Grain | against Grain | with Grain | against Grain |
| Velocity (ft/s) | 409.2 | 419.3 | 423.6 | 412.7 | 403 | 419.3 | 416.9 | 405.8 |
| Peak-G-force | 4490 | 4320 | 4250 | 4730 | 5570 | 5730 | 4100 | 5590 |
| Damping | 1.6 ms | 1.5 ms | 2.1 ms | 3.2 ms | 2.5 ms | 3.7 ms | 7.6 ms | 4.6 ms |
| Duration | | | | | | | | |
| (high frequency) | | | | | | | | |
| Damping | 20 ms | 9.7 ms | 18.5 ms | 17.5 ms | 17.75 ms | 19.5 ms | 18.5 ms | 19.0 ms |
| Duration | | | | | | | | |
| (low frequency) | | | | | | | | |

Results

As can be seen in Table 1, the Bamboo sticks (Tests 3, 4, 7, & 8) performed at least as well in acceleration (velocity and peak g-force) and damping low frequency vibration as did the hickory sticks. Further the bamboo sticks performed better than the traditional sticks in damping high-frequency vibration.

The scope of the invention is set forth in the claims appended hereto, subject, for example, to the limits of language. Although specific terms are employed to describe the invention, those terms are used in a generic and descriptive sense and not for purposes of limitation. Moreover, while certain presently preferred embodiments of the claimed invention have been described herein, those skilled in the art will appreciate that such embodiments are provided by way of example only. In view of the teachings provided herein, certain variations, modifications, and substitutions will occur to those skilled in the art. It is therefore to be understood that the invention may be practiced otherwise than as specifically described, and such ways of practicing the invention are either within the scope of the claims, or equivalent to that which is claimed, and do not depart from the scope and spirit of the invention as claimed.

We claim:

1. A drumstick comprising one or more agricultural fibers that do not include woody xylem wherein the drumsticks are more susceptible to denting and more resistant to chipping and splintering than comparable hickory drumsticks.

2. The drumstick of claim 1 wherein the agricultural fibers comprise bamboo.

3. The drumstick of claim 1 wherein the agricultural fibers consist essentially of bamboo.

4. The drumstick of claim 1 wherein the agricultural fibers are nonwoven.

5. The drumstick of claim 1 wherein the agricultural fibers are woven.

6. The drumstick of claim 1 wherein the agricultural fibers are compressed at a pressure of between 400 to 2000 tons during manufacture.

7. The drumstick of claim 1 that is less subject to shatter than a comparable hickory stick because it sufficiently weakens and produces faded sound over time with repeated use so as to indicate to a user of the drumstick that it should be replaced.

8. The drumstick of claim 1 that when compared to a comparable hickory drumstick under standardized test conditions: a) performs at least as well in one or more of acceleration (velocity and peak g-force) or damping low frequency vibration; and b) performs better than the hickory drumsticks in damping high-frequency vibration.

9. The drumstick of claim 1 wherein the butt end of the drumstick has about a 90-degree angle relative to the long axis of the drumstick, and wherein when the butt end of the drumstick is used to strike a surface of a percussion instrument, the angle of attack is substantially greater than with a drumstick having a round butt-end.

10. A pair of drumsticks matched for size and weight wherein at least one of the pair of drumsticks comprises woven or nonwoven bamboo.

11. The pair of drumsticks of claim 10 wherein the drumstick comprising bamboo is pressed to 400 to 2000 tons of pressure during manufacture.

12. The pair of drumsticks of claim 10 having a butt-end that has about a 90-degree angle relative to the long axis of the drumstick, and wherein when the butt end of the drumstick is used to strike a surface of a percussion instrument, the angle of attack is substantially greater than with a drumstick having a round butt-end.

13. The pair of drumsticks of claim 10 wherein at least one of the drumsticks when compared to a comparable hickory drumstick under standardized test conditions: a) performs at least as well in one or more of acceleration (velocity and peak g-force) or damping low frequency vibration; and b) performs better than the hickory drumsticks in damping high-frequency vibration.

14. The pair of drumsticks of claim 10 wherein the bamboo is nonwoven.

15. The pair of drumsticks of claim 10 wherein the bamboo is woven.

16. A kit comprising one or more drumsticks according to claim 1 and one or more percussion instruments, and optionally, instructions for using the drumsticks or playing the percussion instrument.

17. A method of manufacturing a drumstick comprising the steps of obtaining an agricultural fiber, adding resin to form a mixture, compressing the mixture, drying the material to a desired moisture level, and forming dowels from which to manufacture drumsticks.

18. The method of claim 17 wherein the compressing is performed at between 400 to 2000 tons of pressure.

19. The method of claim 17 further comprising the step of interweaving the fibers at a point prior to forming the dowels.

20. The method of claim 17 further comprising the step of matching weight, density, and/or size of the sticks to create a matched pair of sticks.
